(19) United States
(12) Patent Application Publication
(10) Pub. No.: US 2015/0379472 A1
(43) Pub. Date: Dec. 31, 2015

(54) METHOD AND SYSTEM FOR PROJECT MANAGEMENT

(71) Applicant: PAYPAL, INC., San Jose, CA (US)

(72) Inventors: Tom S. Gilmour, Los Gatos, CA (US); Ramesh Kannappan, Cupertino, CA (US); Mary Ngoc-Dung Bui-Pham, San Jose, CA (US); Leonard E. Greene, San Jose, CA (US); Anant D. Uttarwar, Sunnyvale, CA (US); Cindy Lam, South San Francisco, CA (US)

(21) Appl. No.: 14/849,504

(22) Filed: Sep. 9, 2015

Related U.S. Application Data
(63) Continuation of application No. 12/130,881, filed on May 30, 2008.

(51) Int. Cl. G06Q 10/10; G06F 3/0484; G06F 17/30; G06Q 10/06; G06F 3/0482

(52) U.S. Cl. CPC G06Q 10/103; G06Q 10/063114; G06F 3/0482; G06F 17/30126; G06F 3/04842

(57) ABSTRACT

In one example embodiment, a system and method is shown that includes receiving a plurality of appropriation amounts and corresponding requested amounts associated with a project. The system and method also includes tabulating the plurality of received appropriation amounts and requested amount data in a budget table. Further, initiating an approval request for a requested amount may also be implemented. In an additional embodiment, the system and method include sending the approval request to one or more approvers using an email system. Further, the system and method includes receiving an approval response from the approvers using the email system. Moreover, the system and method includes updating the budget table to indicate the status of the approval request.

### CROSS-REFERENCE TO RELATED APPLICATION

The application is a continuation of U.S. application Ser. No. 12/130,881 filed May 30, 2008, titled “Method and System for Project Management”, all contents of which are herein incorporated by reference in their entirety for all purposes.

### TECHNICAL FIELD

The present application relates generally to the technical field of project management and, in one specific example, to allow for tracking and managing projects.

### BACKGROUND

Planning, organization and managing resources are required for the successful completion of specific project goals and objectives. Achieving project goals and objectives while adhering to quality, scope, time and budget constraints is one of the many challenges faced by project managers.

### BRIEF DESCRIPTION OF THE DRAWINGS

Some embodiments are illustrated by way of example and not limitation in the figures of the accompanying drawings in which:

FIG. 1 is screenshot of a Graphical User Interface (GUI) screen, according to an example embodiment, of a capacity planning tool used to enter the quarterly time frame of the project.

FIG. 2 is a screenshot of a GUI screen, according to an example embodiment, of a capacity planning tool illustrating a capacity request queue.

FIG. 3 is a screenshot of a GUI screen, according to an example embodiment, illustrating a capacity request form.

FIG. 4 is a further detailed screenshot of a GUI screen shown in FIG. 3, according to an example embodiment, illustrating the capability of choosing a concept for the capacity request.

FIG. 5 is a further detailed screenshot of a GUI screen shown in FIG. 3, according to an example embodiment, illustrating an update option control for capacity request.

FIG. 6 is a screenshot of a GUI display, according to an example embodiment, that shows the quarterly budget allocation for various projects.

FIG. 7 is screenshot of a GUI display shown in FIG. 6, according to an example embodiment, which allows a budget administrator to enter the operations budget for a particular project and quarterly time frame.

FIG. 8 is a screenshot of a GUI screen, illustrating a Project Management (PMO) Audit Report Tool for project management, according to an example embodiment.

FIG. 9 is a screenshot of a GUI display, showing a Project Management Organization (PMO) Audit Report Tool is provided that includes flags to show status of various projects, according to an example embodiment.

FIG. 10 is a screenshot of a GUI display, showing a menu used to generate an audit rule, according to an example embodiment.

FIG. 11 is a screenshot of a GUI display, illustrating a Visual Roadmap Tool used to view a program including various projects, according to an example embodiment.

FIG. 12 is a screenshot of a GUI display, showing a menu used to add ad-hoc milestones for the program shown in FIG. 11.

FIG. 13 is a screenshot of a GUI display, showing a menu to add/remove projects for the program shown in FIG. 11.

FIG. 14 is a screenshot of a GUI display, showing a visual roadmap of a project, according to some embodiments.

FIG. 15 is a flow diagram illustrating the execution of an operation, according to an example embodiment, used to provide a capacity plan and display budget data.

FIG. 16 is a flow diagram illustrating a Remote Email Approval Tool, according to an example embodiment, used to provide an approval system for project data using email approvals.

FIG. 17 is a flow diagram illustrating the execution of an operation, according to an example embodiment, to provide a visual roadmap of a project that displays a roll-up view.

FIG. 18 is a flow diagram illustrating the execution of an operation, according to an example embodiment, used to provide an audit flow and render project flags based on various audit rules.

FIG. 19 shows a diagrammatic representation of a machine in the form of a computer system, according to an example embodiment.

### DETAILED DESCRIPTION

Example methods and systems to provide real-time project planning and tracking are described herein. In the following description, for purposes of explanation, numerous specific details are set forth to provide a thorough understanding of example embodiments. It will be evident, however, to one of ordinary skill in the art that the various embodiments may be practiced without these specific details. In some example embodiments, a system and method are shown that allow for the real-time project planning and tracking tool in an online environment that allows for resource allocation and determination to be made at the front end before resources are allocated to a particular project/task. The system and methods provided herein allow for visual representation of project time lines, project status and allows for the linking of various projects to determine if a particular project requires the completion of other projects before it can be scheduled to begin.

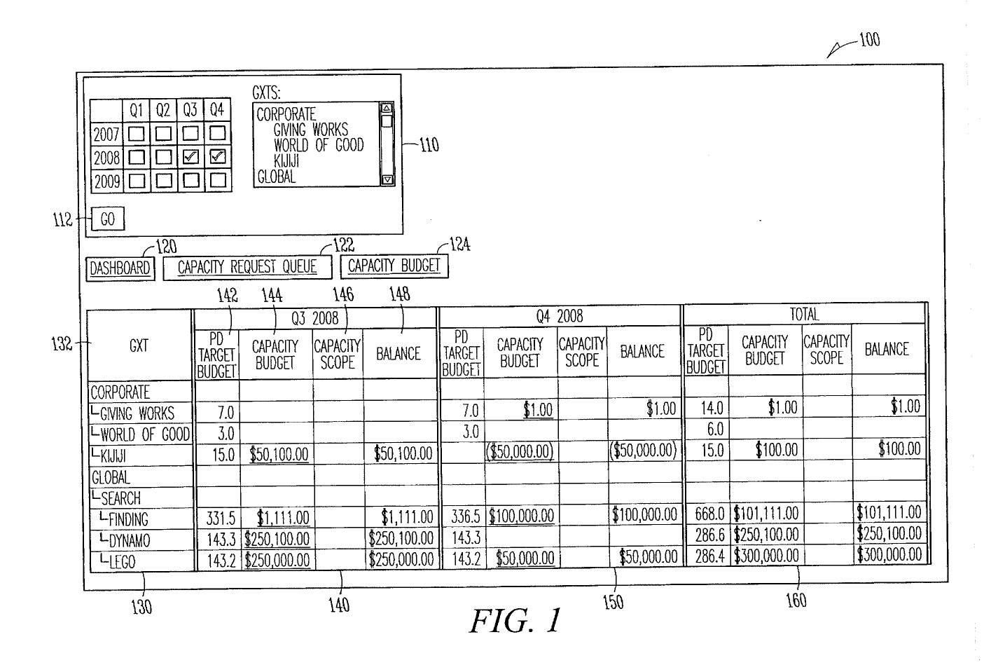

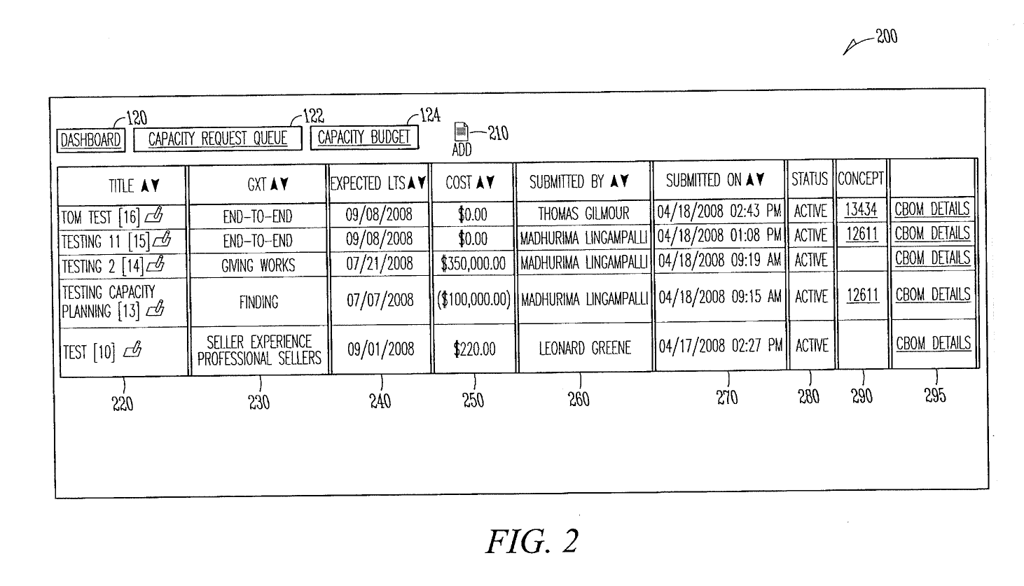

FIG. 1 is screenshot 100 of a Graphical User Interface (GUI) screen, according to an example embodiment, showing a capacity planning tool used to enter the quarterly time frame of a chosen project. In some embodiments, screenshot 100 shows a dashboard area 110 activated by a control button “Dashboard” 120. In some embodiments, Dashboard area 110 is configured to view the project planning tool by various quarters. Dashboard area 110 can be used to select for viewing a time frame (e.g., years namely 2007, 2008, and 2009 having quarters Q1, Q2, Q3, and Q4); a particular project from a set of projects (e.g., Corporate, and Global) including tasks (e.g., Giving Works, World of Good, and Kijiji). Dashboard area 110 also includes a control button (shown as “GO”) that is used to activate the chosen time frames of particular projects displayed in screenshot 100. Screenshot 100 further shows control buttons Capacity Request Queue 122 (described in FIG. 2), and Capacity Budget 124.

Screenshot 100 also shows a table 132 including regions 130, 140, 150 and 160. In some embodiments, region 130 can be configured to list various projects along with their corresponding tasks. Region 140 and 150 correspond to quarters Q3 2008 and Q4 2008, respectively. In some embodiments, region 140 includes a listing for each project a set of columns indicating parameters such as a project development target budget 142, an appropriation amount (capacity budget) 144, a requested amount (capacity scope) 146 and a balance 148, which is the difference between the appropriation amount 144 and the requested amount 146.

FIG. 2 is a screenshot 200 of a GUI screen, according to an example embodiment, of a capacity planning tool illustrating a capacity request queue. Screenshot 200 shows control buttons dashboard 120, capacity request queue 122, and capacity budget 124 and add button 210. Screenshot 200 shows a list of projects for which appropriations of funds or resources are requested by various project managers. In some embodiments, the titles of the request for appropriation are listed in column 220. In some embodiments, the names of the project for which the request is made are listed in column 230. In some embodiments, the expected start dates of the projects are listed in column 240. In some embodiments, the cost of the project is listed in column 250. In some embodiments, the names of the requesting project managers or personnel are listed in column 260. In some embodiments, the date of submission of the appropriation request is provided in column 270. In some embodiments, the status of the appropriation requests requested by personnel listed in column 260 is listed in column 280. A concept is a project that has not been scoped or assigned resources. It is essentially a project in the planning phase of the project life cycle. The CBOM details column provides a link to a Capacity Build of Materials detail screen.

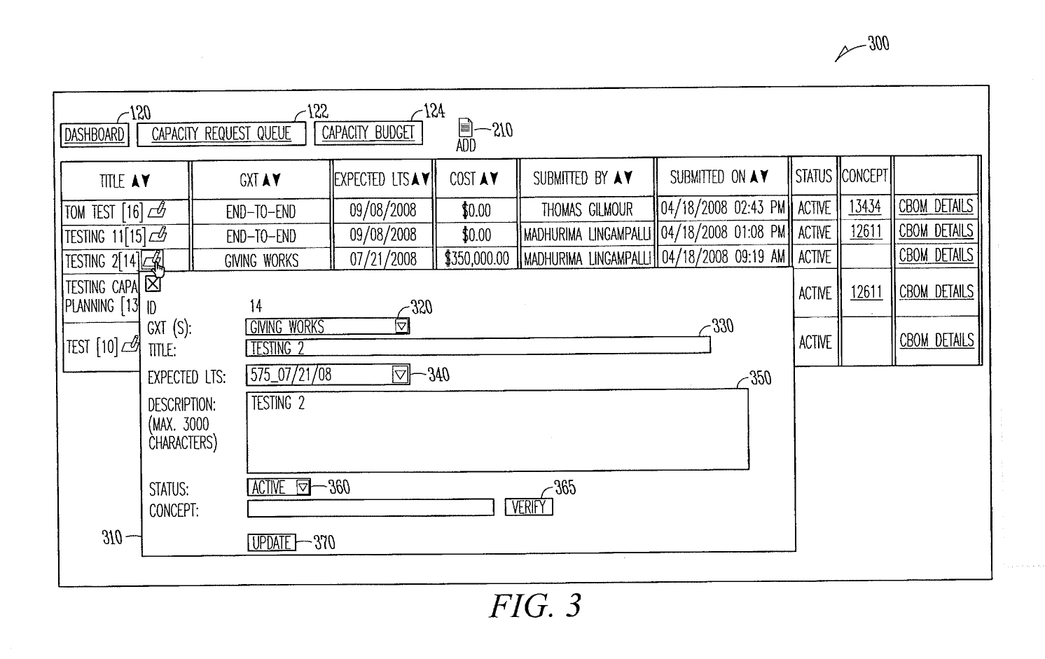

FIG. 3 is a screenshot 300 of a GUI screen, according to an example embodiment, illustrating a capacity request form 310 which is a window that can be opened by clicking the icon positioned on or near the appropriation request titled “Testing 2[14].” In some embodiments, window 310 is a drop down menu button 320 that expands to show different projects (GXTs), a title field 330 identifying the name of the appropriation request, a start date field 340 indicating the start date of the project, a description block 350 provided to record any particular information pertaining to the appropriation request or the project for which appropriation is requested, a status field 360 which can have any number of status designations such as “Active”, “Inactive”, “Terminated”, “Suspended” etc., to describe the status of the appropriation request. The “Verify” button allows the user to verify the Concept name within the Tracker database. The user can select a valid concept if results are returned.

In some embodiments, window 310 can be used to select, change or add particular values for the various field of the appropriation and screen 300 can then be updated using update button 370.

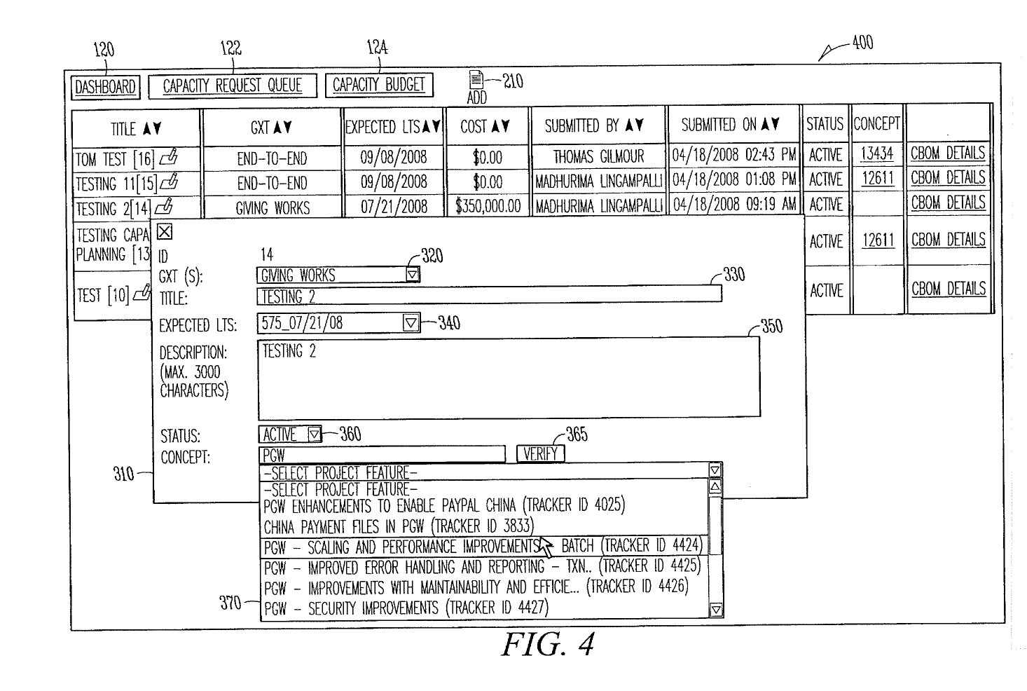

FIG. 4 is a further detailed screenshot 400 of a GUI screen 300 as shown in FIG. 3, according to an example embodiment, illustrating the capability of choosing a concept (such as a “project feature”) for the capacity request. Screenshot 400 shows window 310 including a drop down menu 370 that can be used to select a concept associated with the corresponding appropriation request.

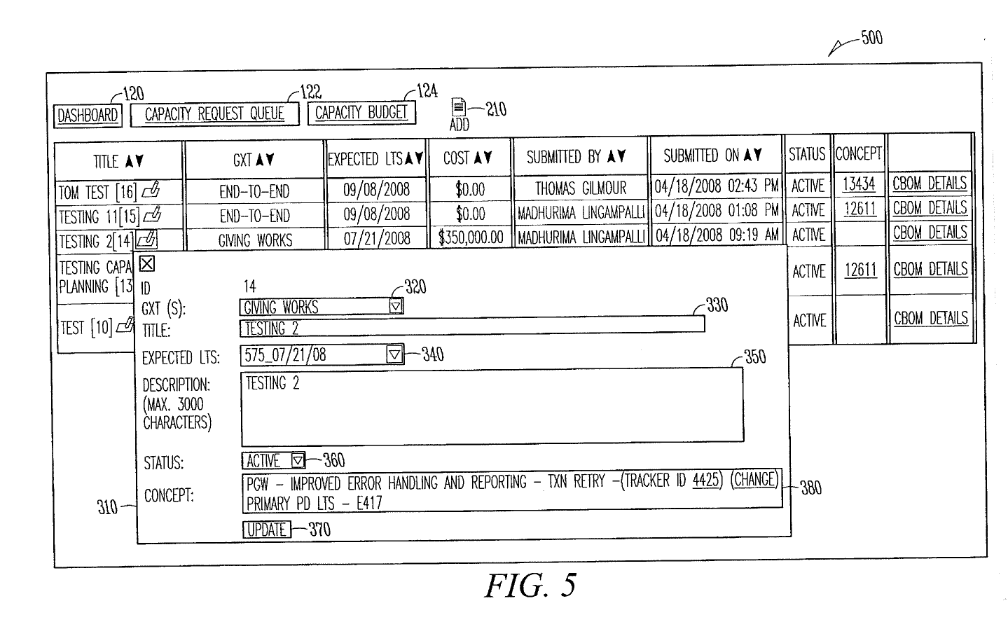

FIG. 5 is a further detailed screenshot 500 of a GUI screen 300 as shown in FIG. 3, according to an example embodiment, illustrating an update option control 370 for capacity request. Screenshot 500 shows a detail window 310 including a field 380 having a concept selected and associated with the corresponding appropriation request.

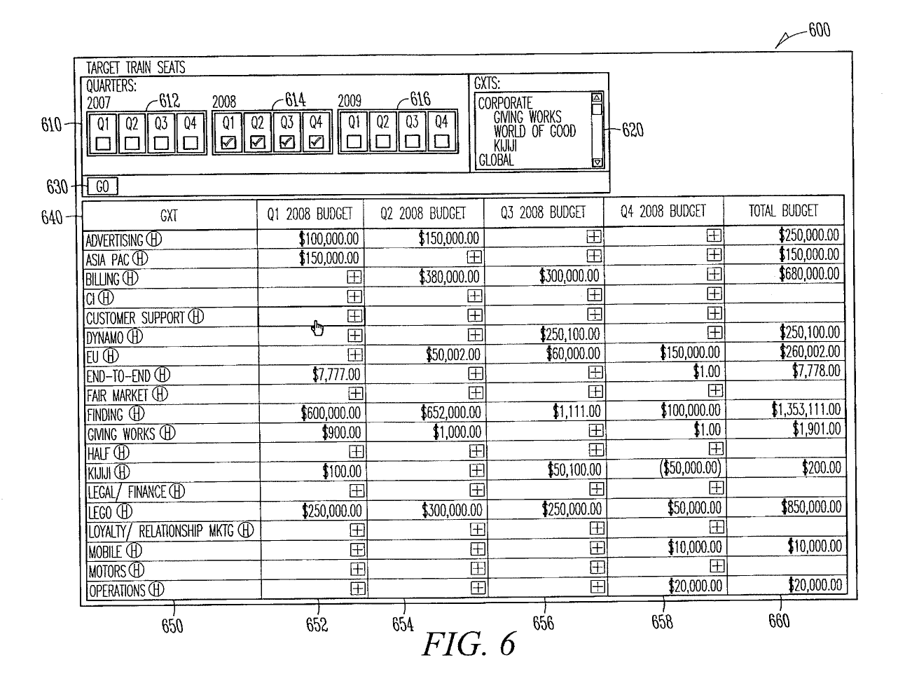

FIG. 6 is a screenshot 600 of a GUI display, according to an example embodiment, that shows a the quarterly budget allocation for various projects. Screenshot 600 shows a dashboard 610 including fields 612, 614 and 616 corresponding to years 2007, 2008 and 2009, respectively. Dashboard 610 also includes a scrollbar 620 that may be used to scroll up or down for the selection of a particular project from the list of projects. Column 650 lists the various projects that are active for quarters Q1, Q2, Q3 and Q4 of year 2008. Columns 652, 654, 656 and 658 show the corresponding appropriation budgets provided for the various projects listed in column 650.

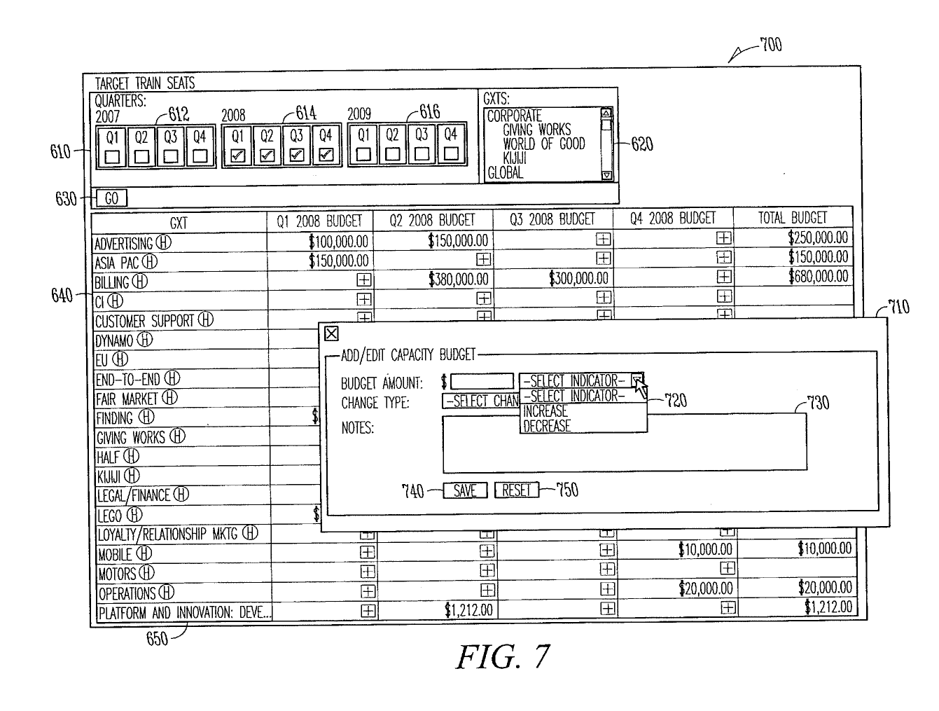

FIG. 7 is screenshot 700 of a GUI display 600 shown in FIG. 6, according to an example embodiment, which allows a budget administrator to enter the operations budget for a particular project and quarterly time frame. Screenshot 700 shows a pop up window 710 that is generated by clicking on any of the cells under the Q1, Q2, Q3 and Q4 columns in fields 612, 614, and 616. Window 710 provides for adding or editing the capacity budget. Typically this is done at the corporate or divisional level. The requested amounts are provided by the working group level. The working group can request changes in the appropriation amounts (capacity budgets) but cannot change the amounts directly. Working groups can change the “requested amount” based on their projections of what resources are needed to perform the project tasks. In some embodiments, by using window 710, a new budget amount can be entered in the “Budget Amount” field. In some embodiments, a “Change Type” option is provided with a selection field 720 to select either of two settings namely “Increase” or “Decrease.” Window 710 also includes control buttons 740 and 750 that are used for activating the “Save” and “Reset” function, respectively.

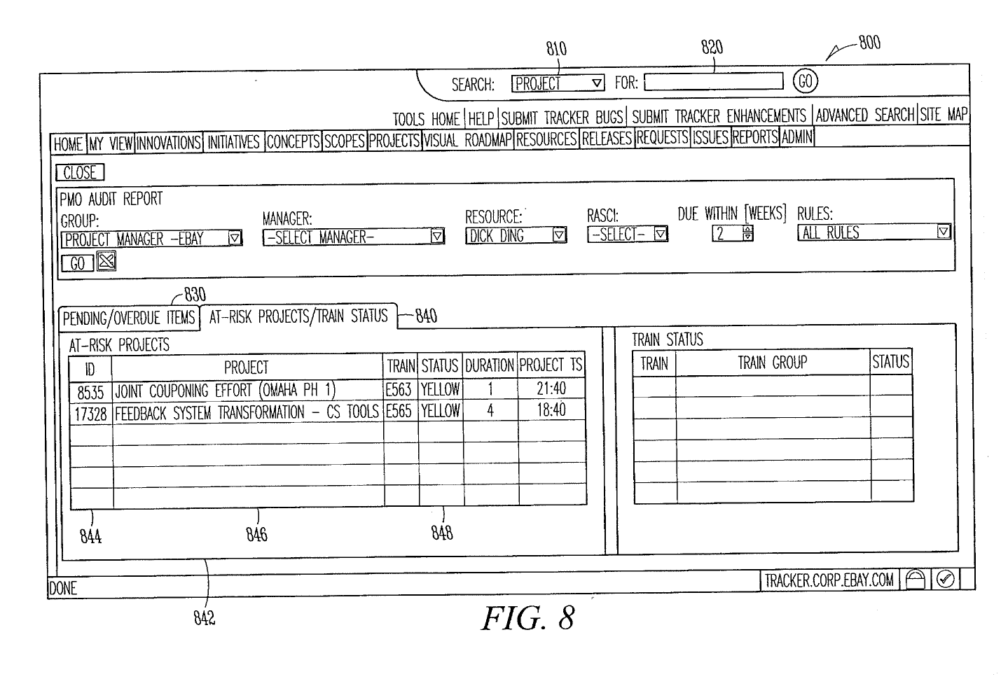

FIG. 8 is a screenshot 800 of a GUI display, illustrating a Project Management Organization (PMO) Audit Report Tool for project management, according to an example embodiment. Screenshot 800 shows a search field 810 including a drop down menu for a list of criteria; for example, Project, Project Managers, Dates of Projects, etc In some embodiments, the search includes a generic search field across any of the tools described herein. Field 820 is provided next to search field 810 to enter text used for searching against the criterion that was selected under search field 810. Screenshot 800 also shows a Project Management Organization (PMO) audit report that has selection options such as Group (including the Project Manager or Product Manager), Manager (to select a particular manager), Resource (e.g. to select a particular software engineer), RASCI—the corporation's decision making process hierarchy (R—Responsible, A—Approver, S—Supporter, C—Consultant, I—Informed). For example; in a situation where there are 5 project managers working on a project, the Project Manager with the “R” designation is the primary contact and decision maker. In some embodiments, the tool also includes a “Due within weeks” drop down menu, and an “Audit Rules” drop down menu to select various audit rules that can be chosen to be applied for a given project or task.

In some embodiments, screenshot 800 further shows control buttons for Pending/Overdue items 830 and At-Risk Projects status 840. In some embodiments, selection of the various at-risk projects button shows a list of projects that are at risk that have their ID listed in column 844, the title of projects listed in column 846, and status field 848. In some embodiments, status field 848 has three colored options (Color Green—representing no risk to the project, Color Yellow—representing that the project is potentially at risk in the near future, Color Red—representing that the project is currently at risk).

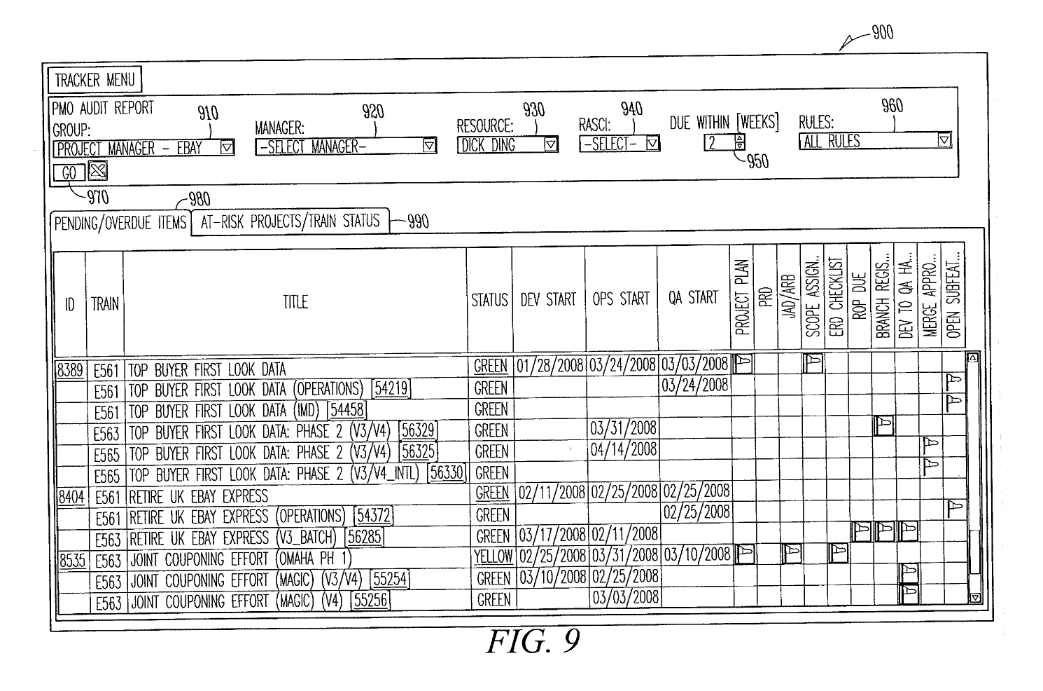

FIG. 9 is a screenshot 900 of a GUI display, showing a Project Management Organization (PMO) Audit Report Tool is provided that includes flags to show status of various projects, according to an example embodiment. Screenshot 900 shows an audit report field including a drop down menus 910, 920, 930, 940, 950 and 960 to select a group, a manager, a resource, a RASCI—the corporation's decision making process hierarchy (R—Responsible, A—Approver, S—Supporter, C—Consultant, I—Informed) Screen shot 900 shows pending/overdue items field 980 and at-risk project field 990, wherein the pending/overdue items field 980 has been selected. Selection of the pending/overdue items 980 field displays a list of project ID with various tasks against each ID, a status column corresponding to each task with appropriate completion dates (such as development date, operations date, quality assurance date) shown in further columns. In some embodiments, various flags are used to identify if the tasks do not conform to a set of audit rules selected using field 960. In some embodiments, the flags are displayed for different categories or activities such as project plan, scope (resource or appropriation) assignment, development to quality assurance hand off, etc. In some embodiments, the flags are associated with project activities such as Project requirement Document (PRD), Architecture Review Board (ARB), Engineering Requirement Document (ERD) checklist, and Roll-out Plan (ROP). Project Requirements Document (PRD), Branch Registration (Source control management tool ClearCase uses branches as a way to develop and deploy software. Each project sub-feature is developed on a branch. Those branches are registered to sub-features within the tool. As a result, a release management personnel or department knows what software code is being deployed on any given week. Software Developers are required to register those branches by a certain date.) An open Sub-feature is a project sub-feature that has not been deployed to production. Once the sub-feature is on production, the sub-feature must be closed. Once all the sub-features of a project are closed, the project is considered completed. If a sub-feature is still open after it was released, the flag shows up in the Audit Tool. In some embodiments, a Merge Approval flag is provided to show whether the Quality Assurance department has signed-off on a sub-feature before it can merge to the main branch of corporation's code (essentially a release).

In some embodiments, a PMO Audit Dashboard is included that provides a way to help project managers keep track of deadlines. In some embodiments, the project manager must make milestones to ensure that the project data is complete and up-to-date. In some embodiments, the PMO tool is designed to accommodate different groups with different milestones. In some embodiments, the primary interface of the PMO tool allows the user to select a project manager and project what milestones are approaching as well as milestones that are missed. In some embodiments, a flag with a red border means the milestone has passed and is unfulfilled. In some embodiments, a flag with no border means that it is due within the selected time frame. In some embodiments, clicking on the flag will take one directly to the data entry point for that task. Once, the task is completed, the flag will disappear after refreshing the data.

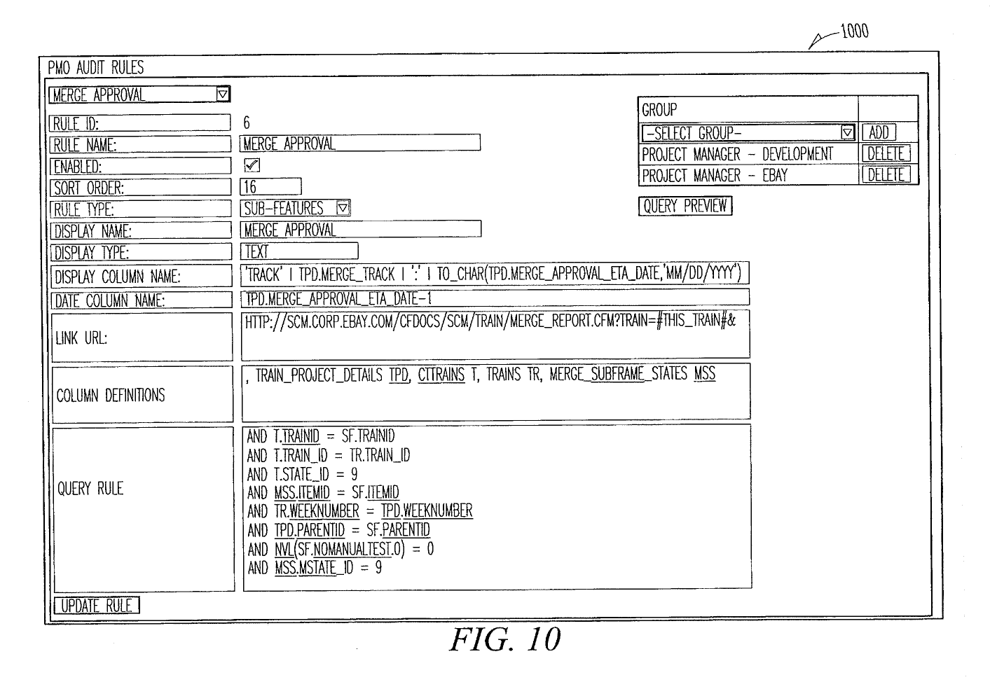

FIG. 10 is a screenshot 1000 of a GUI display, showing a menu provided in the PMO Audit Report Tool used to generate an audit rule, according to an example embodiment. In some embodiments, the rules for the audit report can be defined for different groups. In some embodiments, the PMO audit report tool allows the user to input more rules without performing any source code changes.

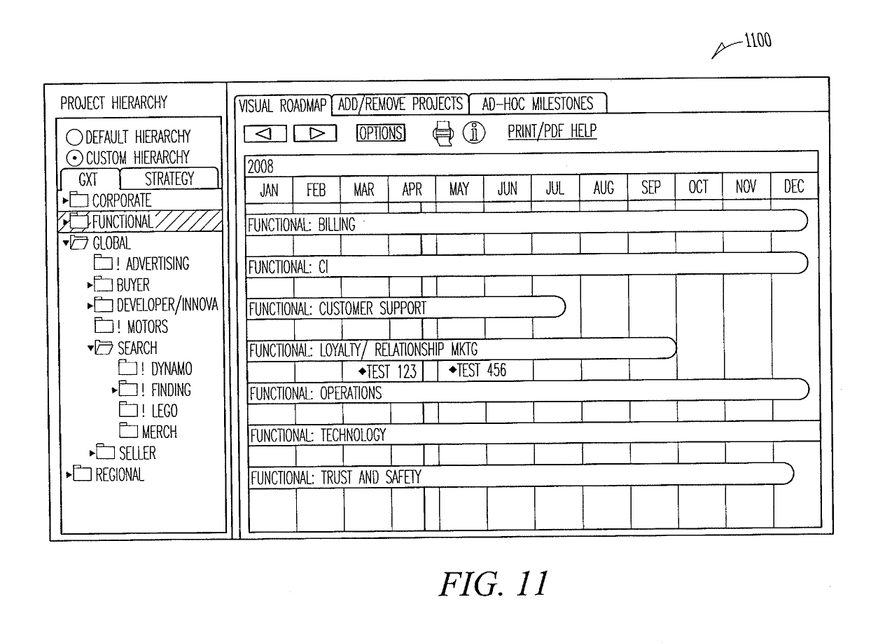

FIG. 11 is a screenshot 1100 of a GUI display, illustrating a Visual Roadmap Tool used to view a program including various projects, according to an example embodiment. In some embodiments, the Visual Roadmap Tool provides a hierarchy of analysis such that executives and/or other managers can see where and how a project is progressing. In some embodiments, the granularity of the details of the progress of projects can be varied. In some embodiments, a progress bar or counter (such as for e.g., Coding—20% complete etc.) is provided for each of the tasks monitored. In some embodiments, the visual roadmap tool visually represents all of the dependencies impacting a particular project which allows the user to better understand the business rules of that particular project. In some embodiment, the user of the tool can find a project for milestones that are due or overdue. In some embodiments, the user is capable of viewing any violations for a given project over a space of time the user selects.

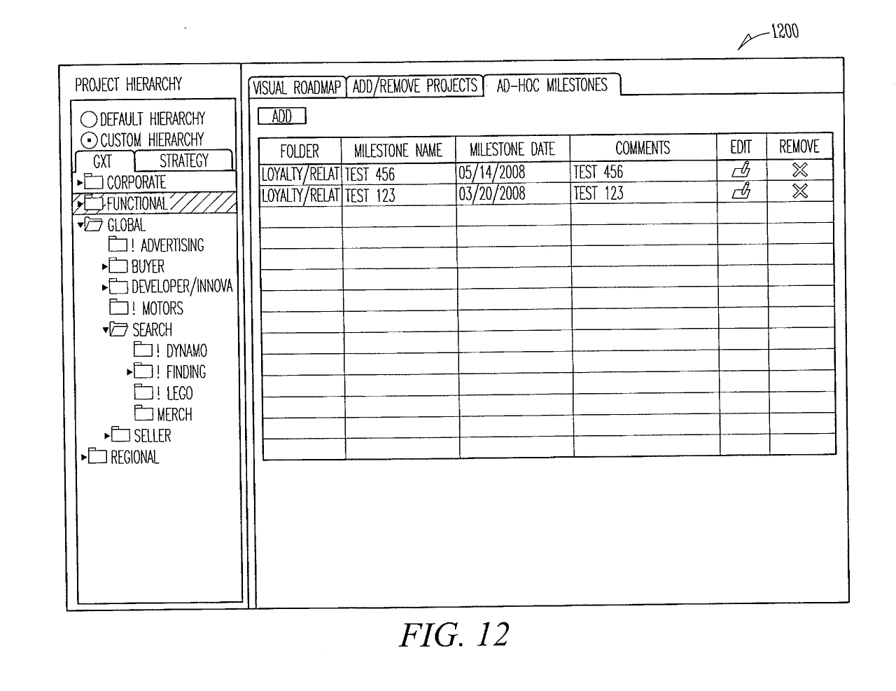

FIG. 12 is a screenshot 1200 of a GUI display, showing a menu used to add ad-hoc milestones for the program shown in FIG. 11. In some embodiments of the user can manually enter a milestone at a folder level and choose to provide the data to the executive level.

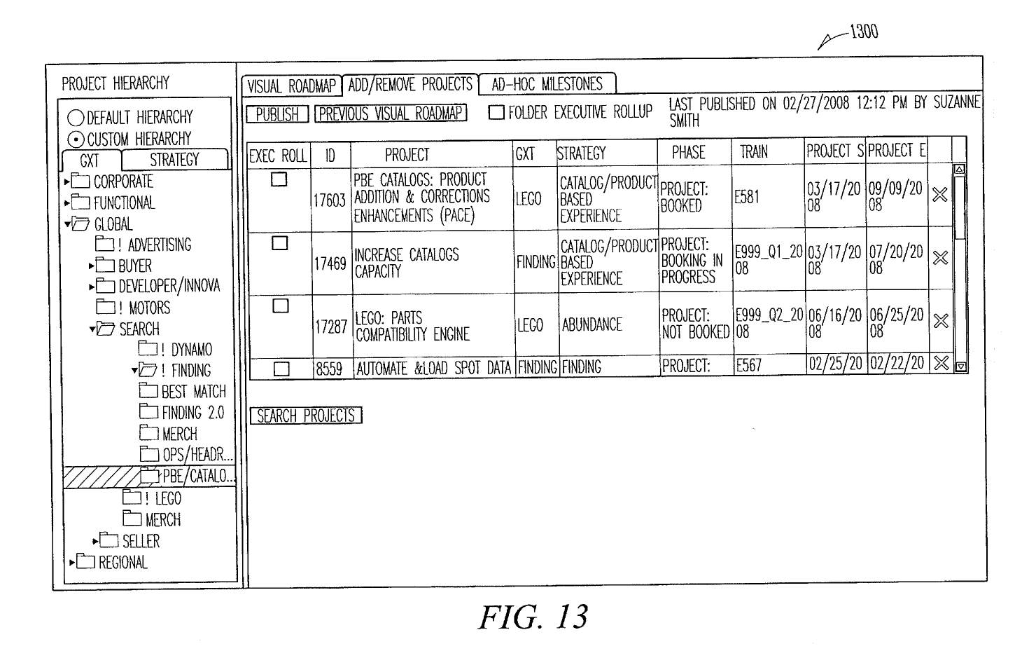

FIG. 13 is a screenshot 1300 of a GUI display, showing a menu to add/remove projects for the program shown in FIG. 11. In some embodiments, the user can associate a project to a folder and allow it to be surfaced to the executive rollup level.

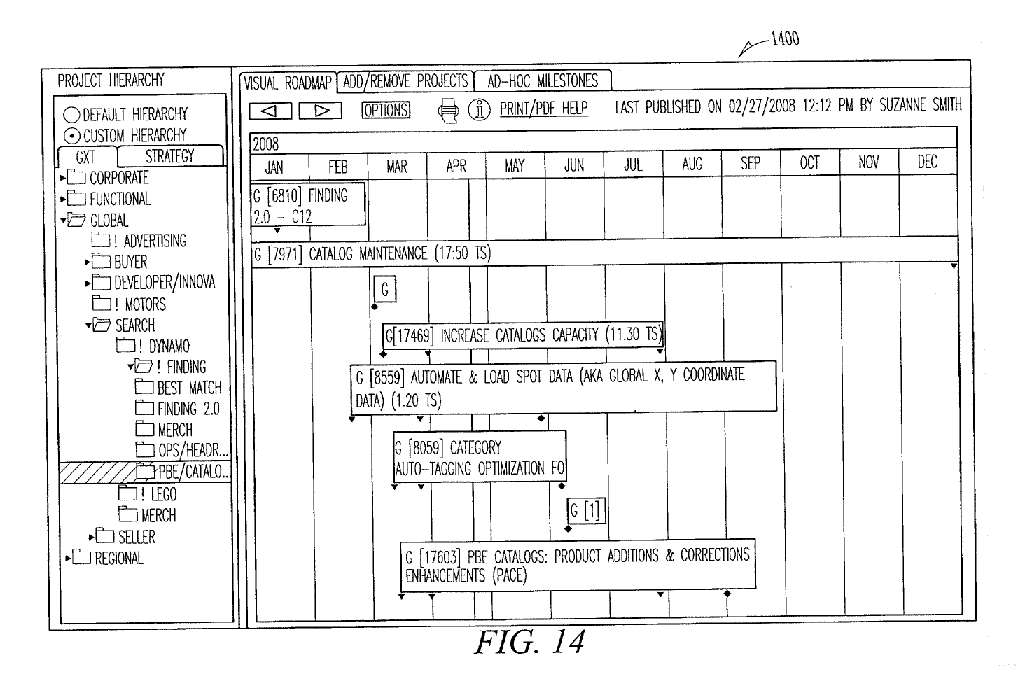

FIG. 14 is a screenshot 1400 of a GUI display, illustrating a Visual Roadmap Tool used to provide a visual roadmap of a project, according to some embodiments. In some embodiments, the user can view the project start and end, plus selected or added milestones in a graphical timeline by selecting the folders that contain the projects.

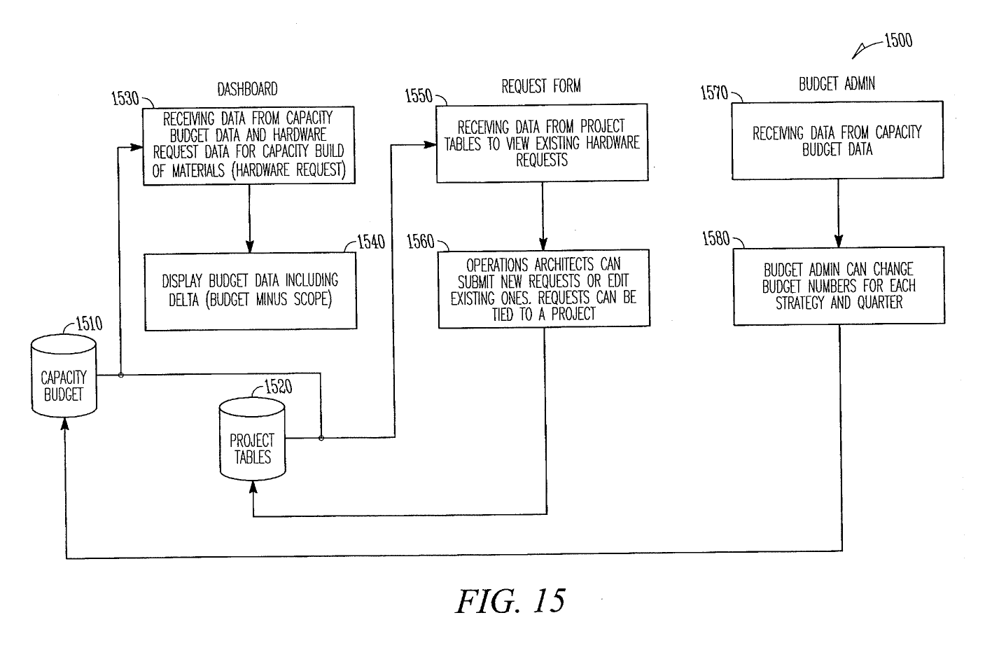

FIG. 15 is a flow diagram 1500 illustrating the execution of an operation, according to an example embodiment, used to provide a capacity plan and display budget data. Flow diagram 1500 includes a capacity budget block 1510, which provides data to the project tables block 1520 and to the dashboard at block 1530 and the request form at block 1550. At block 1530, the operation receives data from the capacity budget (appropriation data) along with hardware request data (scope data or requested data) associated with a particular hardware request. The operation proceeds from block 1530 to block 1540 that provides for displaying of the budget data and the difference between the budget data and scope data (requested data).

At block 1550, in some embodiments, a request form receives data from block 1520 that include project tables, in order to view existing hardware requests. The operation proceeds from block 1550 to block 1560. At block 1560, operations architects (managers) can submit new requests or edit existing ones, wherein the requests can be tied to a project. In some embodiments, the various requests are linked to project tables at block 1520.

In some embodiments, during a budget administration operation, block 1570 receives capacity budget data. At block 1580, in some embodiments, budget administrator can change the budget numbers for each of the various strategies and quarters.

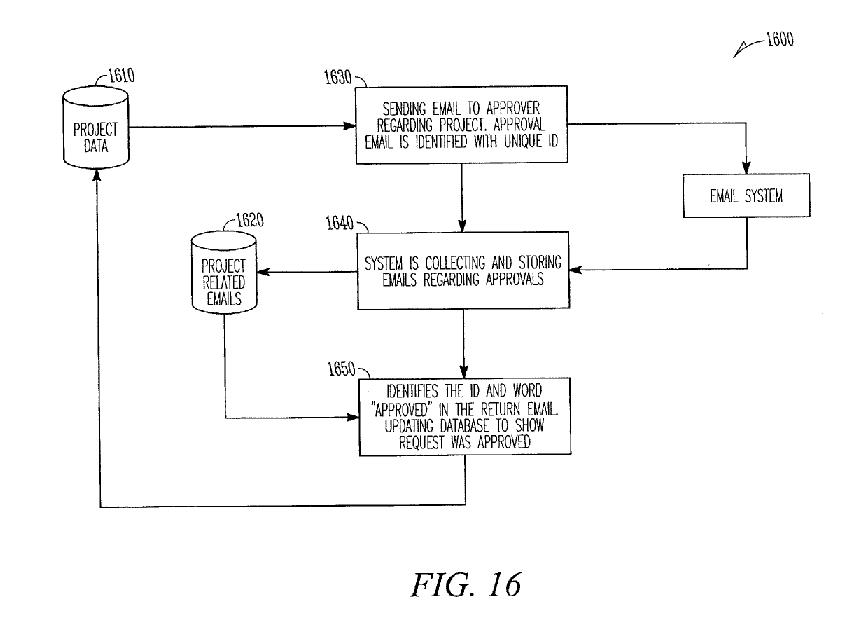

FIG. 16 is a flow diagram 1600 illustrating the operation of a Remote Email Approval Tool, according to an example embodiment, used to provide an approval system for project data using email approvals.

In some embodiments, the process of approval includes the following: (a) a request is made to increase a budget item, (b) the tool takes the request and marks it “Pending Approval,” (c) an email is sent to the approver asking for approval, (d) the approver types “Approved” in the reply email, (e) the Remote Email Approval Tool receives the “Approved” message and updates the request to “Approved” in the system and consequently the budget item is updated to the new value that was approved.

In some embodiments, block 1610 provides project data to block 1630. At block 1630, the operation provides for emails to be sent to an email system that allows an approver to receive an email regarding approval for a project. In some embodiments, block 1630 includes providing an approval email to be identified with a unique ID. At block 1640, the operation provides for the approval emails sent from and to the approver to be collected and stored. At block 1650, the operation provides for identifying the ID and word “Approved” in the return email. Additionally, block 1650 the operation provides for updating the database to show request was approved.

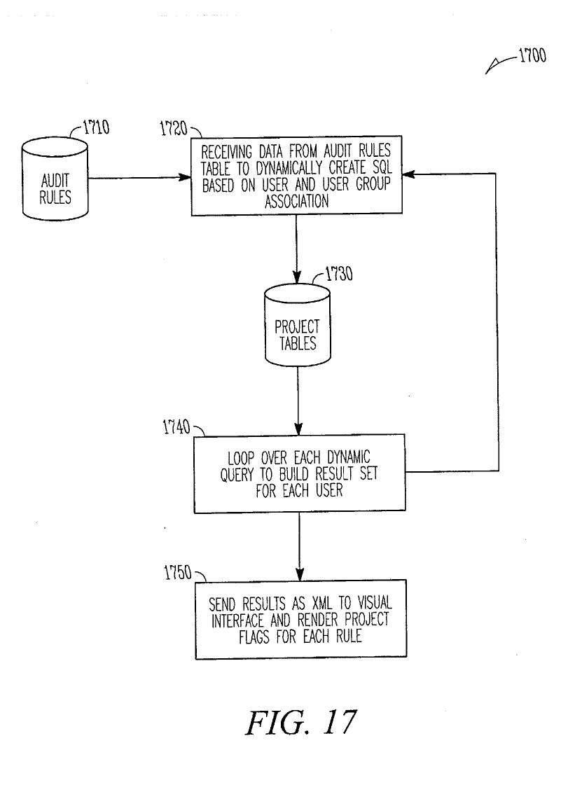

FIG. 17 is a flow diagram 1700 illustrating the operation of a Visual Roadmap Tool, according to an example embodiment, to provide a visual roadmap of a project that displays a roll-up view. In some embodiments, block 1710 provides a table of audit rules. At block 1720, the operation allows for receiving data from audit rules table to dynamically create SQL based on user and user group association. The operation proceeds from block 1720 to block 1730, which includes project tables. The operation proceeds from block 1730 to block 1740. At block 1740, the operation loops over each dynamic query to build a result set for each user. In some embodiments, at block 1750, the operation sends results as XML to visual interface and renders project flags for each rule.

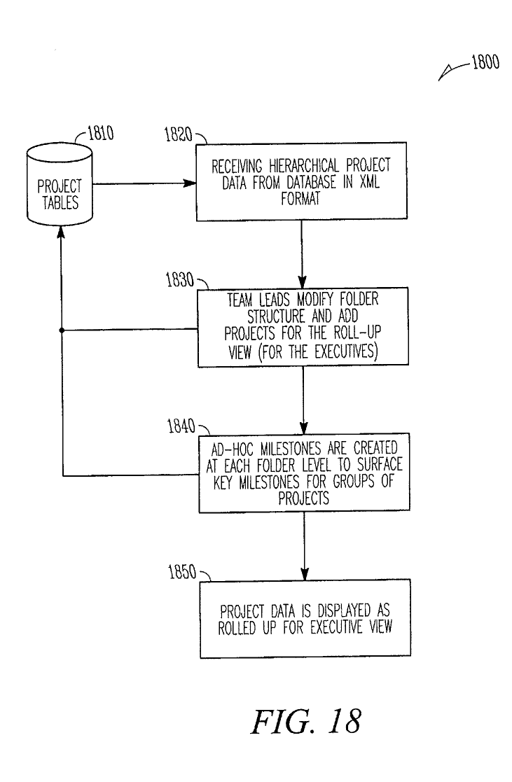

FIG. 18 is a flow diagram 1800 illustrating the execution of an operation, according to an example embodiment, used to provide an audit flow and render project flags based on various audit rules. In some embodiments, at block 1810, the operation provides project tables. The operation proceeds from block 1810 to block 1820. At block 1820, the operation provides hierarchical project data from database in XML format. The operation proceeds from block 1820 to block 1830. At block 1830, the operation provides for a team lead to modify folder structure and add projects for the roll-up view (for the executives). The operation proceeds from block 1830 to block 1840. At block 1840, the operation provides for ad-hoc milestones to be created at each folder level to surface key milestones for groups of projects. The operation further proceeds from block 1840 to block 1850. At block 1850, the operation provides for the project data to be displayed as rolled up for executive view.

### Example Storage

Some embodiments may include the various databases for capacity budget (1510), project tables (1520, 1730, 1810), project data (1610), and project related emails (1620) as being relational databases, or in some cases On-Line Analytical Processing (OLAP) based databases. In the case of relational databases, various tables of data are created, and data is inserted into and/or selected from these tables using Structured Query Language (SQL) or some other database-query language known in the art. In the case of OLAP databases, one or more multi-dimensional cubes or hypercubes containing multidimensional data, which data is selected from or inserted into using a Multidimensional Expression (MDX), may be implemented. In the case of a database using tables and SQL, a database application such as, for example, MYSQL™, SQLSERVER™, Oracle 8I™, 10G™, or some other suitable database application may be used to manage the data. In the case of a database using cubes and MDX, a database using Multidimensional Online Analytic Processing (MOLAP), Relational Online Analytic Processing (ROLAP), Hybrid Online Analytic Processing (HOLAP), or some other suitable database application may be used to manage the data. These tables or cubes made up of tables, in the case of, for example, ROLAP, are organized into a RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

### A Three-Tier Architecture

In some embodiments, a method is described as implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier and/or to a backend or storage tier. These logical/mathematical manipulations may relate to certain business rules, or processes that govern the software application as a whole. A third, storage tier, may be a persistent or non-persistent storage medium. In some cases, one or more of these tiers may be collapsed into another, resulting in a two-tier or even a one-tier architecture. For example, the interface and logic tiers may be consolidated, or the logic and storage tiers may be consolidated, as in the case of a software application with an embedded database. This three-tier architecture may be implemented using one technology, or as will be discussed below, a variety of technologies. This three-tier architecture, and the technologies through which it is implemented, may be executed on two or more computer systems organized in a server-client, peer-to-peer, or some other suitable configuration. Further, these three tiers may be distributed between more than one computer system as various software components.

### Component Designs

Some example embodiments may include the above described tiers, and processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Enterprise Java Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may reside on a first computer system that is located remotely from a second computer system containing a logic component (e.g., a logic tier). These first and second computer systems may be configured in a server-client, peer-to-peer, or some other suitable configuration. These various components may be written using the above-described object-oriented programming techniques and can be written in the same programming language or in different programming languages. Various protocols may be implemented to enable these various components to communicate regardless of the programming language(s) used to write them. For example, a component written in C++ may be able to communicate with another component written in the Java programming language through use of a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or the Transmission Control Protocol/Internet Protocol (TCP/IP) protocol stack model for defining the protocols used by a network to transmit data.

### A System of Transmission Between a Server and Client

Some embodiments may use the Open Systems Interconnection (OSI) basic reference model or Transmission Control Protocol/Internet Protocol (TCP/IP) protocol stack model for defining the protocols used by a network to transmit data. In applying these models, a system of data transmission between a server and client, or between peer computer systems is described as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. The TCP segment also contains port information for a recipient software application residing remotely. The TCP segment is loaded into the data load field of an IP datagram residing at the network layer. Next, the IP datagram is loaded into a frame residing at the data link layer. This frame is then encoded at the physical layer, and the data is transmitted over a network such as the Internet, Local Area Network (LAN), Wide Area Network (WAN), or some other suitable network. In some cases, the word “internet” refers to a network of networks. These networks may use a variety of protocols for the exchange of data, including the aforementioned TCP/IP. These networks may be organized within a variety of topologies (e.g., a star topology) or structures.

### A Computer System

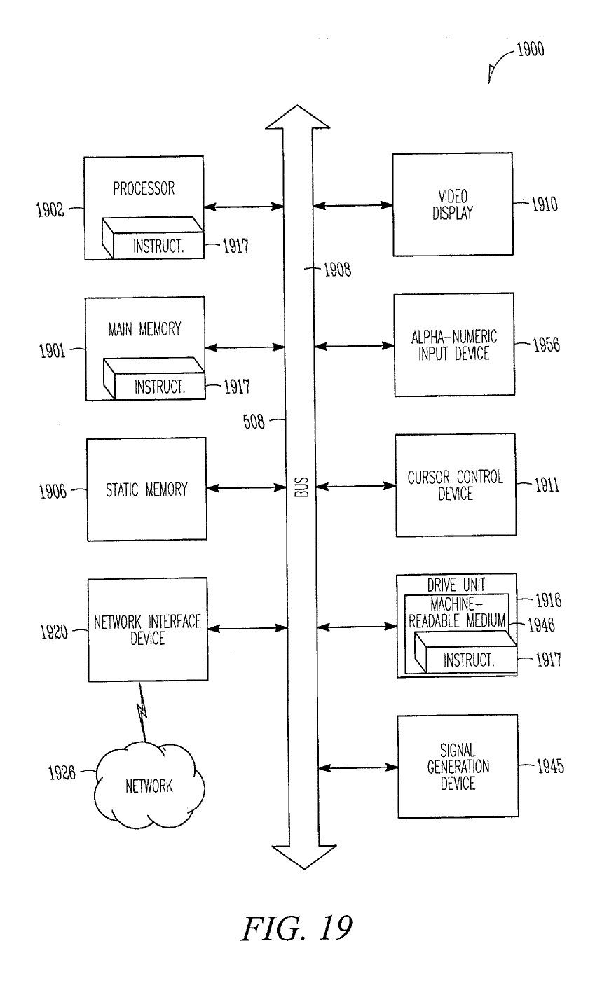

FIG. 19 shows a diagrammatic representation of a machine in the example form of a computer system 1900 within which a set of instructions for causing the machine to perform any one or more of the methodologies discussed herein may be executed. A server may be a computer system. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems that are linked (e.g., either by hardwired, wireless, or a combination of hardwired and wireless connections) through a network both perform tasks. In a distributed system environment, program modules may be located in both local and remote memory-storage devices (see below).

The example computer system 1900 includes a processor 1902 (e.g., a Central Processing Unit (CPU), a Graphics Processing Unit (GPU) or both), a main memory 1901 and a static memory 1906, which communicate with each other via a bus 1908. The computer system 1900 may further include a video display unit 190 (e.g., a Liquid Crystal Display (LCD) or a Cathode Ray Tube (CRT)). The computer system 1900 also includes an alphanumeric input device 1956 (e.g., a keyboard), a User Interface (UI) cursor controller 1911 (e.g., a mouse), a disk drive unit 1916, a signal generation device 1953 (e.g., a speaker) and a network interface device (e.g., a transmitter) 1920.

The disk drive unit 1916 includes a machine-readable medium 1946 on which is stored one or more sets of instructions 1917 and data structures (e.g., software) embodying or used by any one or more of the methodologies or functions described herein. The software may also reside, completely or at least partially, within the main memory 1901 and/or within the processor 1902 during execution thereof by the computer system 1900, the main memory 1901 and the processor 1902 also constituting machine-readable media.

The instructions 1917 may further be transmitted or received over a network 1926 via the network interface device 1920 using any one of a number of well-known transfer protocols (e.g., Hyper Text Transfer Protocol (HTTP), Secure Hyper Text Transfer Protocol (HTTPS)).

In some embodiments, a removable physical storage medium is shown to be a single medium, and the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies described herein. The term “machine-readable medium” shall accordingly be taken to include, but not be limited to, solid-state memories, optical and magnetic media, and carrier wave signals.

### Market Place Applications

Some example embodiments include a Capacity Planning Tool which enables project managers the ability to determine the amount of available capacity (for e.g., human resources, appropriation amounts) for a project. This available capacity may be quantified in the form of labor, cost, time, hardware availability, electrical power availability, and other types of applicable resources.

Some example embodiments include an Executive Rollup Tool which provides a software application interface that allows for a project manager to review milestones, wherein these milestones may be filtered based upon the needs of the project manager. Additionally, a color coding method may be utilized to show or denote progress of a particular project.

Some examples embodiments include a Visual Roadmap Tool that provides a rollup feature akin to a file tree/directory structure. Using this rollup feature progress of a project can be determined using a varying (increasing/decreasing) granularity level via providing a breakdown of the project progress.

Some example embodiments include a PMO audit Tool that displays unattained milestones for a project, and provides associated audit capabilities for the project manager. In addition, various color coding methodologies are provided that can be used to denote particular milestones that are either met, not met or in jeopardy of being met.

Some example embodiments include a Remote Email Approval Tool that provides project managers and executives interested in a particular project to receive email, SMS, or other electronic method to receive updates of project progress, audits, and the like. In some embodiments, the approver can approve projects using a mobile device such as a Blackberry®. Further, approval may be sought for moving forward with certain milestones using email, SMS etc.

The Abstract of the Disclosure is provided to comply with 37 C.F.R. §1.72(b), requiring an abstract that allows the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer implemented method comprising:
receiving, electronically by a computer system, project data for a plurality of projects associated with a program;
presenting, by the computer system, an electronic user interface displaying a representation of the plurality of projects arranged in hierarchical folders;
receiving, by the computer system via the electronic user interface, a user selection of one of the hierarchical folders;
in response to the receiving the user selection, updating the electronic user interface to display a visual representation of a graphical timeline corresponding to a project associated with the selected hierarchical folder, wherein the visual representation of the graphical timeline comprises color coded flags indicating status, wherein a color coded flag of a first color indicates that a milestone has been missed, a color coded flag of a second color indicates that a milestone is due within a certain time frame, and wherein the electronic user interface removes from display color coded flags that correspond to completed milestones.

2. The computer implemented method of claim 1, wherein the updating the electronic user interface to display the visual representation of the graphical timeline further comprises displaying a project start and a project end.

3. The computer implemented method of claim 1, further comprising:
receiving, by the computer system via the electronic user interface, a user selection of one of the color coded flags;
in response to receiving the user selection of the one of the color coded flags, taking the user to a data entry point of a task associated with the user selection of the one of the color coded flags.

4. The computer implemented method of claim 1, further comprising:
displaying, by the computer system via the electronic user interface, a menu for adding one or more ad-hoc milestones associated with a corresponding one of the plurality of projects.

5. The computer implemented method of claim 1, further comprising:
receiving, by the computer system, one or more ad-hoc milestones associated with a corresponding one of the plurality of projects entered manually by a user via the electronic user interface.

6. The computer implemented method of claim 1, further comprising:
displaying a menu for adding or removing, by the computer system via the electronic user interface, one or more projects of the plurality of projects associated with the program.

7. The computer implemented method of claim 1, wherein the receiving the project data further comprises receiving the project data in XML format from a database.

8. The computer implemented method of claim 1, further comprising:
providing, by the computer system via the electronic user interface, a roll-up view including displaying the project data associated with a corresponding project along with one or more milestones.

9. The computer implemented method of claim 1, further comprising:
providing, by the computer system, audit capabilities to audit at least one of the plurality of projects.

10. The computer implemented method of claim 1, further comprising:
presenting, by the computer system, the electronic user interface displaying a table having columns corresponding to a plurality of audit rules and rows corresponding to a plurality of pending project tasks to be performed for one of the plurality of projects;
accessing the plurality of audit rules from the table; and
applying the plurality of audit rules to the project data for the pending project tasks of the one of the plurality of projects.

11. The computer implemented method of claim 10, further comprising:
generating, by the computer system, a result based on conformance of the project data for the pending project tasks to the plurality of audit rules.

12. The computer implemented method of claim 11, further comprising:
compiling data from the result set into an XML document to display, by the computer system on the electronic user interface, for each audit rule.

13. The computer implemented method of claim 10, further comprising:
displaying, by the computer system on the electronic user interface, one or more flags in the columns of the table corresponding to the plurality of audit rules to show where violations of the plurality of audit rules are present for each pending project task of the one of the plurality of projects.

14. The computer implemented method of claim 1, further comprising:
displaying, by the computer system on the electronic user interface, related other projects that require completion before the project can begin.

15. A system comprising:
one or more processors; and
one or more memories in communication with the one or more processors and adapted to store a plurality of machine-readable instructions which when executed by the one or more processors are adapted to cause the system to:
receive project data for a plurality of projects associated with a program;
display, on an electronic user interface, a representation of the plurality of projects arranged in hierarchical folders;
receive, via the electronic user interface, a user selection of one of the hierarchical folders;
in response to receiving the user selection, update the electronic user interface to display a visual representation of a graphical timeline corresponding to a project associated with the selected hierarchical folder, wherein the visual representation of the graphical timeline comprises color coded flags indicating status, wherein a color coded flag of a first color indicates that a milestone has been missed, a color coded flag of a second color indicates that a milestone is due within a certain time frame, and wherein the electronic user interface removes from display color coded flags that correspond to completed milestones.

16. The system of claim 15, wherein the one or more processors are further adapted to cause the system to:
receive, via the electronic user interface, a user selection of a project manager associated with one of the plurality of projects; and
in response to receiving the user selection of the project manager, determine at least one of approaching or missed milestones for the one of the plurality of projects.

17. The system of claim 15, wherein the one or more processors are further adapted to cause the system to:
receive a user selection of one of the color coded flags; and
in response to receiving the user selection of the one of the color coded flags, take the user to a data entry point of a task associated with the user selection of the one of the color coded flags.

18. The system of claim 15, wherein the color coded flag of the first color comprises a red color indicating that the milestone has passed and is unfulfilled.

19. The system of claim 15, wherein the color coded flag of the second color comprises no border indicating that the milestone is due within a selected time frame.

20. A non-transitory machine readable medium comprising instructions, which when executed by one or more machines, cause the one or more machines to perform the following operations:
receive project data for a plurality of projects associated with a program;
cause an electronic user interface to display a representation of the plurality of projects arranged in hierarchical folders;
receive, via the electronic user interface, a user selection of one of the hierarchical folders;
in response to receiving the user selection, update the electronic user interface to display a visual representation of a graphical timeline corresponding to a project associated with the selected hierarchical folder, wherein the visual representation of the graphical timeline comprises color coded flags indicating status, wherein a color coded flag of a first color indicates that a milestone has been missed, a color coded flag of a second color indicates that a milestone is due within a certain time frame, and wherein the electronic user interface removes from display color coded flags that correspond to completed milestones.
